(19) United States
(12) Patent Application Publication
(10) Pub. No.: US 2016/0328773 A1
(43) Pub. Date: Nov. 10, 2016

(54) SYSTEMS AND METHODS FOR FACILITATING 3D PRINTING AND ON-DEMAND INDUSTRY DEVELOPMENT

(71) Applicant: OCEAN PRINT LIMITED, Dublin (IE)

(72) Inventors: Shane HASSETT, Abbeyfeale (IE); Marianna KOBALY, Vynohradiv Transcarpathia (UA)

(21) Appl. No.: 15/145,612

(22) Filed: May 3, 2016

Related U.S. Application Data
(60) Provisional application No. 62/156,779, filed on May 4, 2015.

(51) Int. Cl. G06Q 30/06; G06Q 10/08

(52) U.S. Cl. CPC G06Q 30/0621; G06Q 10/0834

(57) ABSTRACT

Systems, methods, apparatuses, and computer program products for facilitating 3D printing and on-demand industry development are provided.

### CROSS-REFERENCE TO RELATED APPLICATION

This application claims the benefit of U.S. Provisional Application No. 62/156,779, filed May 4, 2015, which is incorporated herein by reference.

### BACKGROUND

Embodiments of the invention generally relate to 3D printing or additive manufacturing. In particular, some embodiments relate to methods and systems for facilitating 3D printing and on-demand industry development, for example.

### DESCRIPTION OF THE RELATED ART

3D printing or additive manufacturing may refer to processes used to make a three-dimensional object. 3D printing may utilize additive processes in which successive layers of material are placed down under the control of a computer. The process may be performed by a 3D printer, which is essentially a type of industrial robot. 3D printed objects may be basically of any shape or geometry, and may be produced from a 3D model or other electronic data source.

3D printable models may be created with a computer aided design (CAD) package, a 3D scanner, a plain digital camera and/or photogrammetry software. 3D scanning is a process of analyzing and collecting digital data on the shape and appearance of a real object. Based on this data, three-dimensional models of the scanned object can then be produced.

However, there is a need for a platform that facilitates on-demand product design, approval, manufacture, and/or sale.

### SUMMARY

Briefly and in general terms, the present invention is directed to a method, system, and non-transitory computer readable medium for facilitating 3D printing.

In aspects of the invention, a method comprises: a subscribe step, including using a subscribe step computer application program to create a computer account in a computer system for facilitating 3D printing; a design step, including using a design step computer application program, stored within or in communication with the computer system for facilitating 3D printing, to enter a design description of a product to be manufactured by 3D printing; an evaluate step, including using an evaluate step computer application program, stored within or in communication with the computer system for facilitating 3D printing, to perform any one or more of (a) comparing the product entered in the design step with services offered for manufacturing the product by 3D printing, (b) viewing market history of other products that are related or similar to the product, (c) choosing a service among a plurality of services offered for manufacturing the product by 3D printing, (d) generating a report containing data associated with the comparing and the market history, and (e) creating a code to protect intellectual property of an owner of rights to manufacture the product; a print step, including using a print step application program, stored within or in communication with the computer system for facilitating 3D printing, to initiate or queue a job for manufacturing the product by 3D printing at a selected location; and a deliver step, including using a deliver step application program, stored within or in communication with the computer system for facilitating 3D printing, to perform any one or more of (a) negotiating with a delivery company, a price for delivering the product from the selected location to a purchaser of the product manufactured by 3D printing, (b) selecting a delivery company, from among a plurality of delivery companies, to deliver the product from the selected location to the purchaser, and (c) initiating delivery of the product from the selected location to the purchaser.

In aspects of the invention, a system comprises: a computer processor; and a memory storing an on-demand infrastructure module, wherein the on-demand infrastructure module is configured to execute: a subscribe step, including creating a computer account in the system for an owner of rights to manufacture a product by 3D printing; a design step, including receiving a design description of the product to be manufactured by 3D printing; an evaluate step, including any one or more of (a) comparing the product entered in the design step with services offered for manufacturing the product by 3D printing, (b) presenting market history of other products that are related or similar to the product, (c) receiving a selection of a service among a plurality of services offered for manufacturing the product by 3D printing, (d) generating a report containing data associated with the comparing and the market history, and (e) creating a code to protect intellectual property of an owner of rights to manufacture the product; a print step, including initiating or queuing a job for manufacturing the product by 3D printing at a selected location; and a deliver step, including any one or more of (a) facilitating a negotiation with a delivery company, for a price for delivering the product from the selected location to a purchaser of the product manufactured by 3D printing, (b) selecting a delivery company, from among a plurality of delivery companies, to deliver the product from the selected location to the purchaser, and (c) initiating delivery of the product from the selected location to the purchaser.

In aspects of the invention, a non-transitory computer readable medium comprises: instructions for creating a computer account in a computer system for facilitating 3D printing; instructions for receiving a design description of a product to be manufactured by 3D printing; instructions for any one or more of (a) comparing the product entered in the design step with services offered for manufacturing the product by 3D printing, (b) presenting market history of other products that are related or similar to the product, (c) receiving a selection of a service among a plurality of services offered for manufacturing the product by 3D printing, (d) generating a report containing data associated with the comparing and the market history, and (e) creating a code to protect intellectual property of an owner of rights to manufacture the product; instructions to initiate or queue a job for manufacturing the product by 3D printing at a selected location; and instructions for any one or more of (a) facilitating a negotiation with a delivery company, for a price for delivering the product from the selected location to a purchaser of the product manufactured by 3D printing, (b) selecting a delivery company, from among a plurality of delivery companies, to deliver the product from the selected location to the purchaser, and (c) initiating delivery of the product from the selected location to the purchaser.

### BRIEF DESCRIPTION OF THE DRAWINGS

For proper understanding of the invention, reference should be made to the accompanying drawings, wherein:

FIGS. 1A-1D show an example process or system architecture according to one embodiment; and

FIG. 2 illustrates an example block diagram of an apparatus according to an embodiment.

FIGS. 3-5 show various features of the process or system architecture of FIGS. 1A-1D.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for facilitating 3D printing and on-demand industry development, as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Certain embodiments provide a unique flexible digital platform that allows current obvious and unforeseen stakeholders to plug in and have the possibility of designing, offering, approving, marketing, manufacturing, and/or buying the goods on demand. An embodiment operates on the principle of totality and transforms the physical business processes, including financial, legal, sales into easy digital clicks.

As mentioned above, one embodiment facilitates 3D printing and on-demand industry development, market growth, sales and consumer uptake. As a result, example embodiments can structure the industry processes and transform currently chaotic individual projects into business logical flow. All stakeholders within 3D Printing industry can be connected with on-demand oriented businesses and individuals. All parties in the 3D printing industry and on-demand oriented businesses and individuals are enabled to seamlessly interact to complete an on-demand and secure transaction.

Embodiments of the invention provide the infrastructure, for example in the form of hardware and/or software, for all stakeholders to be able to operate and easily communicate via a suitable and secure platform for generating and performing content business activities. As a result, the full potential of 3D printing and on-demand industry are unleashed, thereby providing a worldwide network where anyone at any place and time can communicate the need and/or offer, simplify and shorten the overall supply chain by enabling the physical processes to become digital. Embodiments reduce time to market, simplify currently complicated activities (e.g., legal, financial, etc.), allow any individual or business to exploit the best practices available throughout the world on demand, and create a secure environment for 3D printing industry and on-demand business stakeholders to communicate and interact.

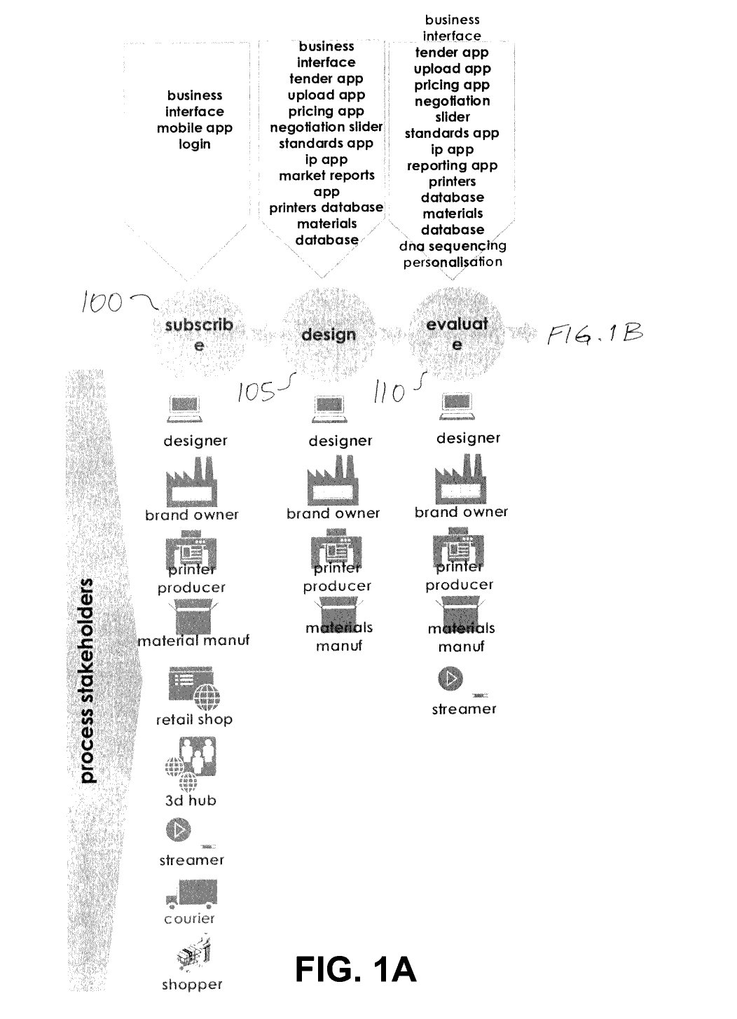

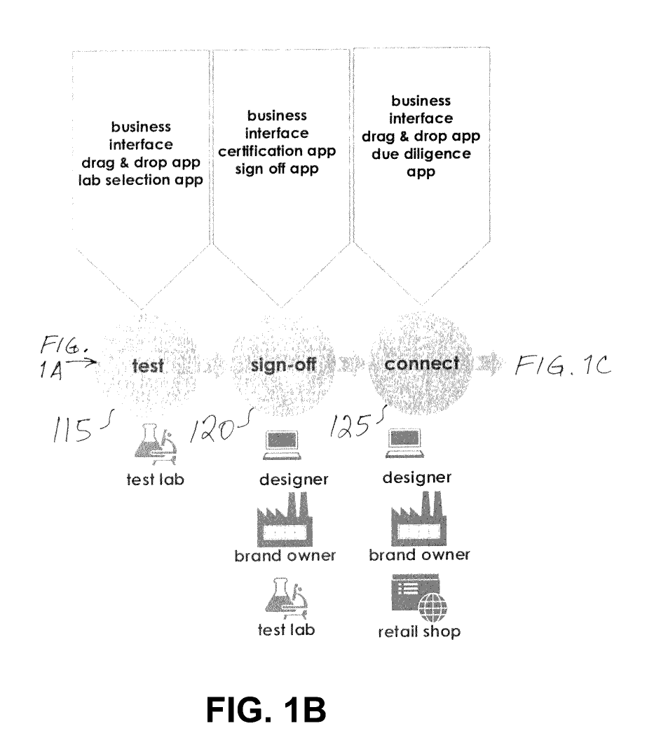

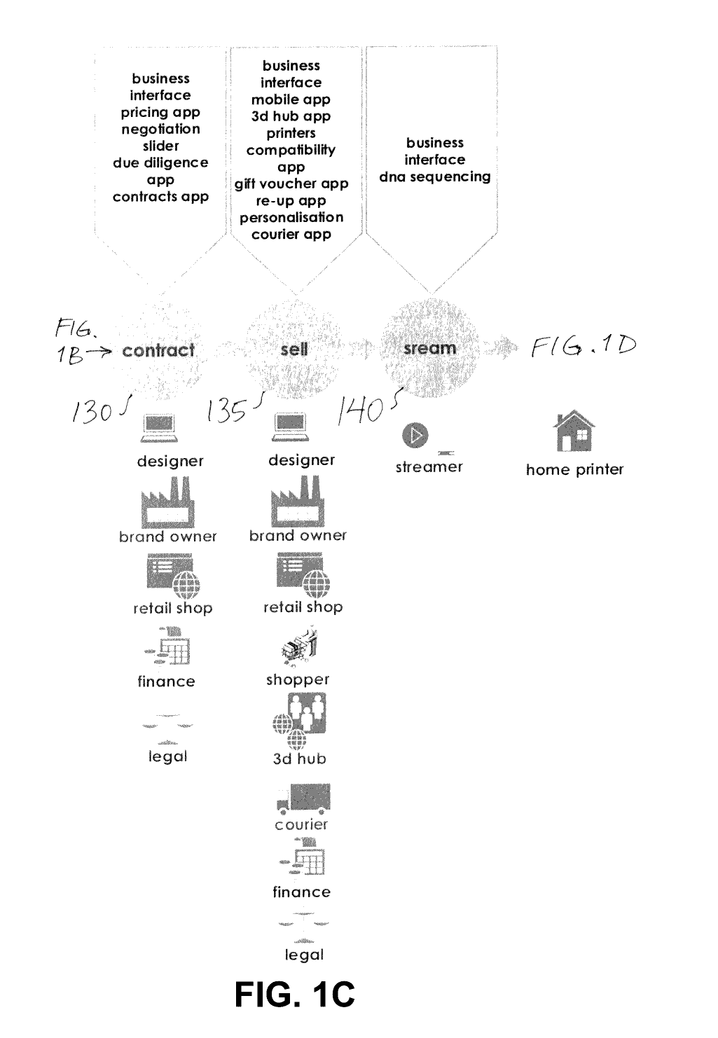

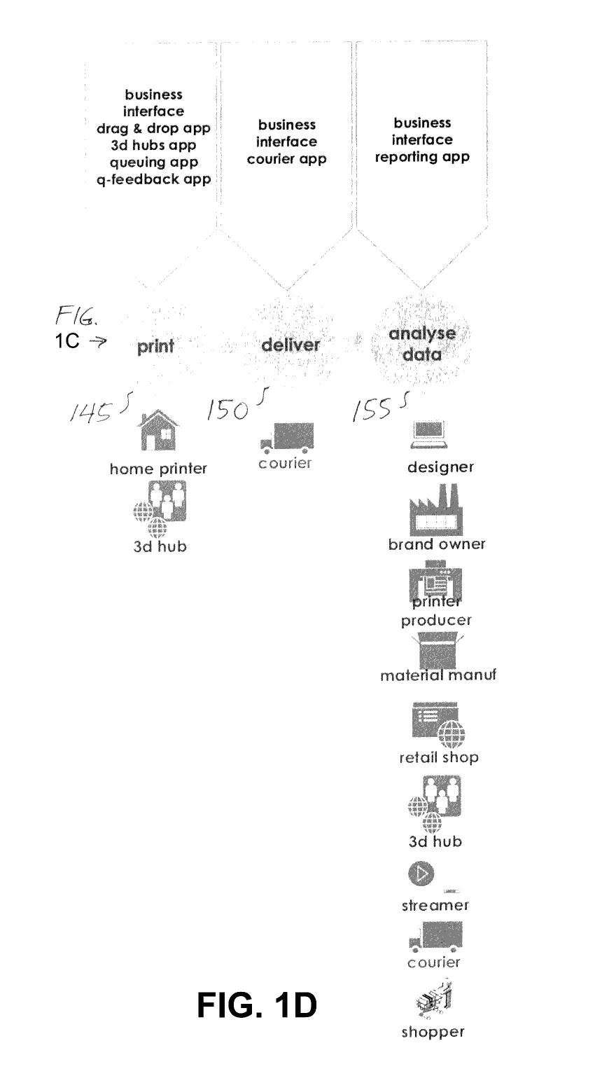

FIGS. 1A-1D illustrate an example process or system architecture according to one embodiment. As illustrated in FIGS. 1A-1D, the process may involve or include various stakeholders. For example, stakeholders may include: designers that can create and offer product designs (e.g. 3D product designs); brand/product owners or companies that have products for sale (e.g., 3D printed products); 3D printer manufacturers; materials manufacturers (i.e., companies producing materials for 3D printers); test laboratories that are a body accredited to perform the testing and certification of 3D products based on industry norms; legal companies advising on legal aspects within business activities, such as contracts, intellectual property rights, etc; financial companies advising on financial and tax aspects within business activities, such as transfer pricing, due diligence, etc.; couriers providing transportation or delivery of products/goods; 3D Hubs which are companies or individuals having one or more 3D printers, compatible to print the specified quality of product and willing to offer printing service; shoppers/consumers who are seeking to purchase a product that can be 3D printed; streamers which are software companies or developers that have the adequate solution for secure streaming of files from the cloud to a 3D printer; and online retailers or e-commerce websites.

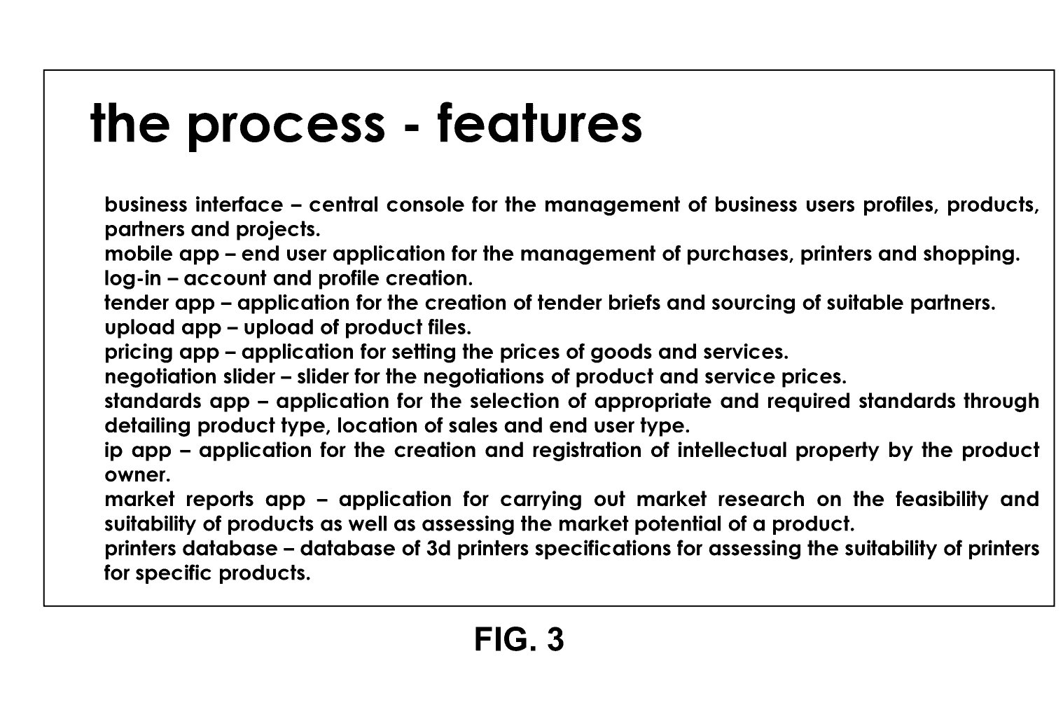

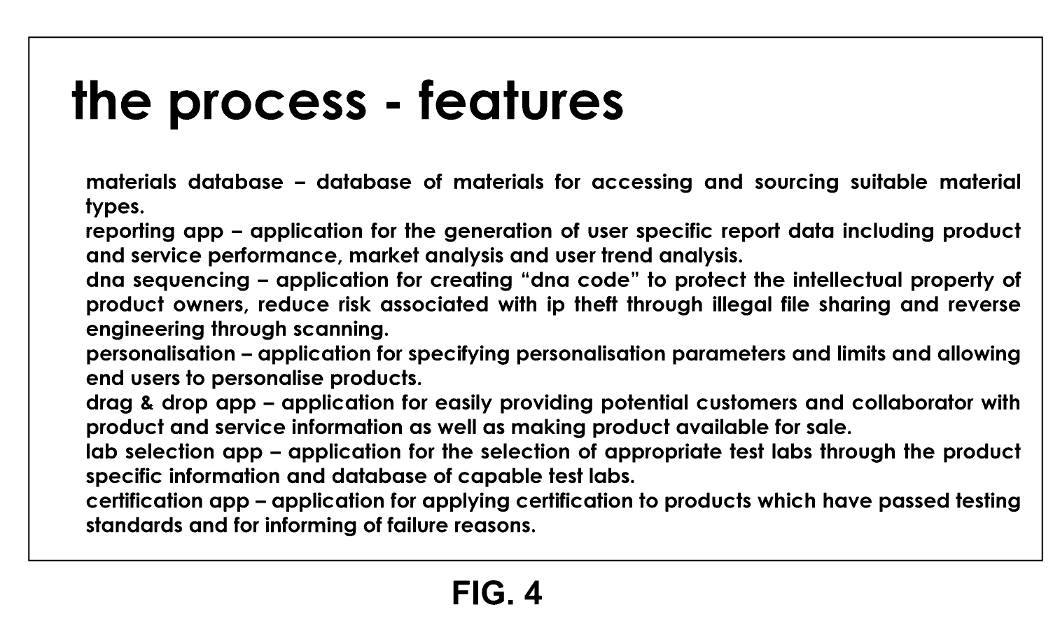

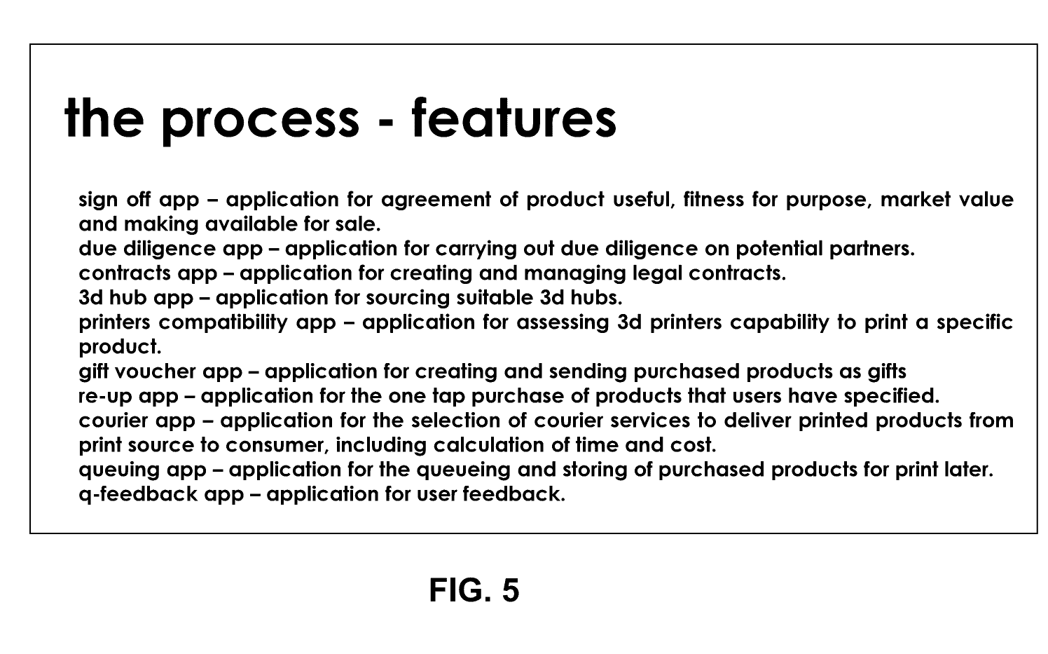

As illustrated in the example of FIG. 1A, the process flow begins with a subscription step 100 which may require any of the stakeholders mentioned above to provide specific stakeholder data in order to create secure environment and network. In an embodiment, the subscription step 100 may be facilitated by a business interface app (computer application program) that functions as a central console for the management of business users profiles, products, partners and projects. In addition, a mobile app may be provided as an end user application for the management of purchases, printers and shopping. A log-in process for account and profile creation may be included in the business interface app and/or the mobile app. A subscribe step computer application program may include any one or a combination of the above described apps (computer application programs) used in the subscription step. FIGS. 3-5 show further details of the business interface app, mobile, app, and other application programs mentioned below.

Next, the process flow may include a design step 105 that may incorporate applications for communicating a requestor's need and requirements, the respondents' capabilities, a database of available technology and materials, offer designs and on-demand services, tender and negotiate. For example, the design step 105 may incorporate a tender app as an application for the creation of tender briefs and sourcing of suitable partners, an upload app for upload of product files, a pricing app for setting the prices of goods and services, a negotiation slider for the negotiations of product and service prices, a standards app for the selection of appropriate and required standards through detailing product type, location of sales and end user type, an IP app for the creation and registration of intellectual property by the product owner, a market reports app for carrying out market research on the feasibility and suitability of products as well as assessing the market potential of a product, a printers database for storing 3d printers' specifications for assessing the suitability of printers for specific products, and a materials database for storing information for accessing and sourcing suitable material types. A design step computer application program may include any one or a combination of the above described apps (computer application programs) used in the design step.

In certain embodiments, the process flow may continue with an evaluate step 110 that incorporates the applications for easy comparison and analysis of demanded products and services offered, double-check the market history of related or similar products and services, and choose the most appropriate offer. In addition to the apps mentioned above in connection with the design step 105, the evaluate step 110 may also include a reporting app for the generation of user specific report data including product and service performance, market analysis and user trend analysis, a DNA sequencing application for creating “dna code” to protect the intellectual property of product owners, reduce risk associated with IP theft through illegal file sharing and reverse engineering through scanning, and a personalisation application for specifying personalisation parameters and limits and allowing end users to personalise products. An evaluate step computer application program may include any one or a combination of the above described apps (computer application programs) used in the evaluate step.

According to an embodiment, the process flow of FIG. 1B may continue with a test step 115 that may incorporate a database and selection of the appropriate accredited test body, digital submission, negotiation and contracting between the requestor and tester, as well as communication of results. The test step 115 may incorporate the business interface app, a drag & drop app for easily providing potential customers and collaborator with product and service information as well as making product available for sale, and a lab selection app for the selection of appropriate test labs through the product specific information and database of capable test labs. A test step computer application program may include any one or a combination of the above described apps (computer application programs) used in the test step.

In some embodiments, the process flow may continue with a sign-off step 120 that may incorporate the applications for digital signing off by tester, issuing a certificate, and signing off by requestor that the product or service is ready to market. The sign-off step 120 may incorporate the business interface app discussed above, a certification app for applying certification to products which have passed testing standards and for informing of failure reasons, and a sign-off app for agreement of product usefulness, fitness for purpose, market value and making available for sale. A sign-off step computer application program may include any one or a combination of the above described apps (computer application programs) used in the sign-off step.

The process flow of FIG. 1B may continue with a connect step 125 that may incorporate the applications for searching and sending requests and acceptance to sell, print or manufacture and deliver, performing online due-diligence, negotiating the prices and easy drag and drop content products interface. The connect step 125 may incorporate the business interface and drag & drop apps discussed above, as well as a due diligence app for carrying out due diligence on potential partners. A connect step computer application program may include any one or a combination of the above described apps (computer application programs) used in the connect step.

In an embodiment, the process flow may the proceed to a contract step 130 that may include entering business agreements (including terms & conditions, price lists, etc.) between stakeholders relevant for a demanded product or service. The contract step 130 may incorporate the business interface app, pricing app, negotiation slider, due diligence app, and a contracts app for creating and managing legal contracts. A contract step computer application program may include any one or a combination of the above described apps (computer application programs) used in the contract step.

According to certain embodiments, the process flow of FIG. 1C may next proceed to a sell step 135 that may incorporate the sale/purchase of a product based on the signed contract. The sell step 135 may include the option of personalization of the demanded 3d printable product within limits specified by the design step 105. In addition to the business interface and mobile apps, the sell step 135 may also incorporate a 3D hub app for sourcing suitable 3d hubs, a printers compatibility app for assessing 3d printers capability to print a specific product, a gift voucher app for creating and sending purchased products as gifts, a re-up app for the one tap purchase of products that users have specified, and a courier app for the selection of courier services to deliver printed products from the print source to a consumer, including calculation of time and cost. A sell step computer application program may include any one or a combination of the above described apps (computer application programs) used in the sell step.

In an embodiment, the process flow may continue with a stream step 140 that may include secure streaming of a purchased file to a 3D printer at a selected location. The stream step 140 may incorporate the business interface and DNA sequencing apps discussed above. Next, a print step 145 may be performed in which manufacturing/printing of the demanded product in the selected location is completed. A stream step computer application program may include any one or a combination of the above described apps (computer application programs) used in the stream step. In addition to the business interface, drag & drop, and 3D hubs apps, the print step 145 may also incorporate a queuing app for the queueing and storing of purchased products for print later and a Q-feedback app for user feedback. A print step computer application program may include any one or a combination of the above described apps (computer application programs) used in the print step.

Then, in one embodiment, the process flow may proceed to a deliver step 150 that may incorporate the database of delivery companies, transportation offers, negotiation of prices, selection of the delivery company, and delivery of product to the consumer/shopper. An analyze data 155 may then be performed in which the reporting of sales data including but not limited to time, frequency of purchases, location of production and demand, types of products sold, so that it can be analyzed and applied to business by relevant stakeholders. A deliver step computer application program may be used in the delivery step.

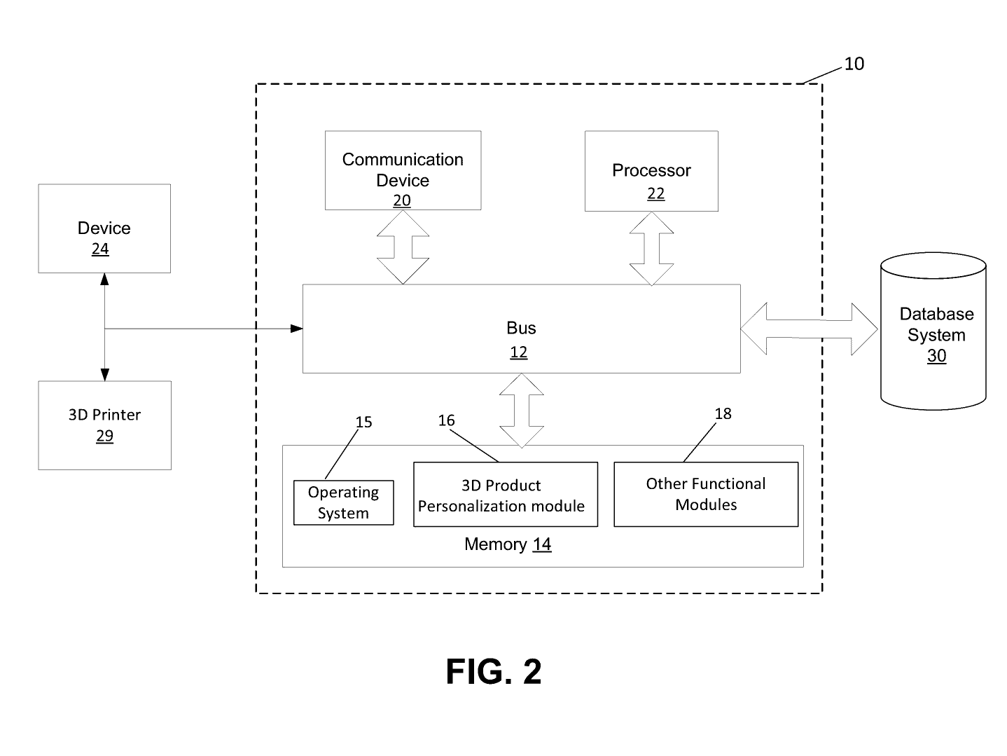

FIG. 2 illustrates a block diagram of an apparatus 10 configured to implement a 3D product personalization system, according to one embodiment. In certain embodiments, apparatus 10 may be a server, such as an application server. Apparatus 10 may include a bus 12 or other communications mechanism for communicating information between components of apparatus 10. Alternatively, the components of apparatus 10 may communicate with each other directly without the use of bus 12.

Apparatus 10 may also include a processor 22, coupled to bus 12, for processing information and executing instructions or operations. Processor 22 may be any type of general or specific purpose processor. Apparatus 10 may further include a memory 14 for storing information and instructions to be executed by processor 22. Memory 14 may be comprised of any combination of random access memory (RAM), read only memory (ROM), static storage such as a magnetic or optical disk, or any other type of machine or computer readable media.

Apparatus 10 may further include a communication device 20, such as a network interface card or other communications interface, to provide access to a network. As a result, a user may interface with apparatus 10 directly or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data, and may include any other form of information delivery medium known in the art. A storage medium may include RAM, flash memory, ROM, erasable programmable read-only memory (EPROM), electrically erasable programmable read-only memory (EEPROM), registers, hard disk, a removable disk, a compact disk read-only memory (CD-ROM), or any other form of storage medium known in the art.

Apparatus 10 or processor 22 may be further in communication via a wired or wireless connection to a device 24. Device 24 may be, for instance, a computer, laptop, tablet, mobile phone, smart phone, or any other electronic device. Also, in an embodiment, processor 22 and memory 14 may be coupled, for example via bus 12 or via a wireless connection, to a 3D printer 29 capable of performing additive manufacturing processes.

Processor 22 and memory 14 may also be coupled via bus 12 to a database system 30 and, thus, may be able to access and retrieve information stored in database system 30. Although only a single database is illustrated in FIG. 2, any number of databases may be used in accordance with certain embodiments. In some embodiments, database system 30 may store information related to 3D products and personalization or customization parameters for the 3D product, as well as any other relevant information.

In one embodiment, memory 14 stores software modules that provide functionality when executed by processor 22. The modules may include an operating system 15 that provides operating system functionality for apparatus 10. The memory may also store an on-demand infrastructure module 16, which can provide the functionality for designing, offering, approving, marketing, manufacturing, and/or selling/buying a 3D product. In some embodiments, on-demand infrastructure module 16 may store one or more web or mobile applications, such as the various apps described above in connection with FIGS. 1A-1D. Apparatus 10 may also include one or more other functional modules 18 to provide additional functionality.

Database system 30 may include a database server and any type of database, such as a relational or flat file database. Database system 30 may store attributes and/or customization parameters related to 3D products. Database system 30 may also store any other data required by the on-demand infrastructure module 16, or data associated with apparatus 10 and its associated modules and components.

In certain embodiments, on-demand infrastructure module 16, and other functional modules 18 may be implemented as separate physical and logical units or may be implemented in a single physical and logical unit. Furthermore, in some embodiments, on-demand infrastructure module 16, and other functional modules 18 may be implemented in hardware, or as any suitable combination of hardware and software.

In one embodiment, memory 14 and on-demand infrastructure module 16, with processor 22, may be configured to control apparatus 10 to execute one or more steps of the process flow of FIGS. 1A-1D discussed above.

In the following, an example use case of an embodiment of the invention will be outlined:
1. A person with an idea for a product which can be marketed subscribes to the system.
2. The person creates a brief of the product in the system and finds designers who can create the design of the described product.
3. After selecting and purchasing the design, a prototype of the product is tested at a lab existing within the system.
4. Once the test is passed, the work can be signed off and a contract between product owner and designer signed.
5. Product owner connects within the system with relevant manufacturers, retailers, legal, financial, delivery companies to create a network of partners needed for marketing his/her product.
6. After all the required business contracts are signed, the product can be sold on-demand to the shopper.
7. If the product is a 3D printable product, it is securely streamed to a printer at a selected location. If the printing location is other than the shopper's home, it is delivered to the shopper after printing.
8. If the product is other than 3D printable, it is delivered to the shoppers' home in a traditional method.

In certain embodiments, all data connected with the activities within system is saved for the purpose of analysis by the stakeholders.

Embodiments of the invention may provide several advantages and/or technical improvements. For example, embodiments through digital activities are able to simplify and shorten the whole supply chain. In addition, as a result of embodiments, goods and services are accessible all over the world closer to the point of demand. As a result of embodiments of the invention, any stakeholder of the process has equal chances to offer or purchase the goods and services and has access to best practices worldwide upon need. Embodiments are able to boost growth of small and medium enterprises worldwide, including countries with underdeveloped economies.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method for facilitating 3D printing, the method comprising:
a subscribe step, including using a subscribe step computer application program to create a computer account in a computer system for facilitating 3D printing;
a design step, including using a design step computer application program, stored within or in communication with the computer system for facilitating 3D printing, to enter a design description of a product to be manufactured by 3D printing;
an evaluate step, including using an evaluate step computer application program, stored within or in communication with the computer system for facilitating 3D printing, to perform any one or more of (a) comparing the product entered in the design step with services offered for manufacturing the product by 3D printing, (b) viewing market history of other products that are related or similar to the product, (c) choosing a service among a plurality of services offered for manufacturing the product by 3D printing, (d) generating a report containing data associated with the comparing and the market history, and (e) creating a code to protect intellectual property of an owner of rights to manufacture the product;
a print step, including using a print step application program, stored within or in communication with the computer system for facilitating 3D printing, to initiate or queue a job for manufacturing the product by 3D printing at a selected location; and
a deliver step, including using a deliver step application program, stored within or in communication with the computer system for facilitating 3D printing, to perform any one or more of (a) negotiating with a delivery company, a price for delivering the product from the selected location to a purchaser of the product manufactured by 3D printing, (b) selecting a delivery company, from among a plurality of delivery companies, to deliver the product from the selected location to the purchaser, and (c) initiating delivery of the product from the selected location to the purchaser.

2. The method of claim 1, further comprising:
a test step, including using a test step application program, stored within or in communication with the computer system for facilitating 3D printing, to perform any one or more of (a) selecting a product tester to test the product, (b) submitting digital data describing the product to the product tester, and (c) negotiating and contracting an agreement between the product tester and the owner of rights to manufacture the product.

3. The method of claim 1, further comprising:
a sign-off step, including using a sign-off step application program, stored within or in communication with the computer system for facilitating 3D printing, to perform any one or more of (a) issuing a sign-off approval by the product tester that the product is ready to market, and (b) issuing a sign-off approval by an the owner of rights to manufacture the product, that the product is ready to market.

2. The method of claim 1, further comprising:
a connect step, including using a connect step application program to perform any one or more of (a) searching, within the computer system for facilitating 3D printing, requests to sell the product, to manufacture the product by 3D printing, and/or to deliver the product from the selected location to the purchaser, and (b) searching for acceptances, within the computer system for facilitating 3D printing, to purchase the product, to manufacture the product by 3D printing, and/or to deliver the product from the selected location to the purchaser.

5. The method of claim 1, further comprising:
a contract step, including using a contract step application program, stored within or in communication with the computer system for facilitating 3D printing, to enter into a contractual business agreement with a party involved in providing materials and/or service for manufacturing the product by 3D printing or a party involved in selling or purchasing the product.

6. The method of claim 1, further comprising:
a sell step, including using a sell step application program, stored within or in communication with the computer system for facilitating 3D printing, to perform any one or more of (a) obtaining from the purchaser, personalization data for incorporating personalized features to the product, and (b) obtaining from the purchaser, courier data for selecting a courier service to deliver the product to the purchaser.

7. The method of claim 1, further comprising:
a stream step, including using a stream step application program, stored within or in communication with the computer system for facilitating 3D printing, to perform streaming of an electronic file containing data for manufacturing the product by 3D printing.

8. The method of claim 1, further comprising:
an analyze data step, including using an analyze data step application program, stored within or in communication with the computer system for facilitating 3D printing, to generate a report including data on sales of the product.

9. A system for facilitating 3D printing, the system comprising:
a computer processor; and
a memory storing an on-demand infrastructure module,
wherein the on-demand infrastructure module is configured to execute:
a subscribe step, including creating a computer account in the system for an owner of rights to manufacture a product by 3D printing;
a design step, including receiving a design description of the product to be manufactured by 3D printing;
an evaluate step, including any one or more of (a) comparing the product entered in the design step with services offered for manufacturing the product by 3D printing, (b) presenting market history of other products that are related or similar to the product, (c) receiving a selection of a service among a plurality of services offered for manufacturing the product by 3D printing, (d) generating a report containing data associated with the comparing and the market history, and (e) creating a code to protect intellectual property of an owner of rights to manufacture the product;
a print step, including initiating or queuing a job for manufacturing the product by 3D printing at a selected location; and
a deliver step, including any one or more of (a) facilitating a negotiation with a delivery company, for a price for delivering the product from the selected location to a purchaser of the product manufactured by 3D printing, (b) selecting a delivery company, from among a plurality of delivery companies, to deliver the product from the selected location to the purchaser, and (c) initiating delivery of the product from the selected location to the purchaser.

10. A non-transitory computer readable medium, having a stored computer program embodying instructions, which when executed by a computer, causes the computer to facilitate 3D printing, the computer readable medium comprising:
instructions for creating a computer account in a computer system for facilitating 3D printing;
instructions for receiving a design description of a product to be manufactured by 3D printing;
instructions for any one or more of (a) comparing the product entered in the design step with services offered for manufacturing the product by 3D printing, (b) presenting market history of other products that are related or similar to the product, (c) receiving a selection of a service among a plurality of services offered for manufacturing the product by 3D printing, (d) generating a report containing data associated with the comparing and the market history, and (e) creating a code to protect intellectual property of an owner of rights to manufacture the product;
instructions to initiate or queue a job for manufacturing the product by 3D printing at a selected location; and
instructions for any one or more of (a) facilitating a negotiation with a delivery company, for a price for delivering the product from the selected location to a purchaser of the product manufactured by 3D printing, (b) selecting a delivery company, from among a plurality of delivery companies, to deliver the product from the selected location to the purchaser, and (c) initiating delivery of the product from the selected location to the purchaser.
